(19) United States
(12) Patent Application Publication
(10) Pub. No.: US 2002/0172049 A1
(43) Pub. Date: Nov. 21, 2002

(54) Protective grill for use of working light

(75) Inventor: Ching Yueh, Taipei (TW)

Correspondence Address: BACON & THOMAS, PLLC, 625 SLATERS LANE, FOURTH FLOOR, ALEXANDRIA, VA, 22314

(73) Assignee: TEST-RITE INTERNATIONAL COMPANY, LTD., Taipei (TW)

(21) Appl. No.: 10/046,306

(22) Filed: Jan. 16, 2002

(30) Foreign Application Priority Data
May 15, 2001 (TW) 90207873

(51) Int. Cl. F21V 15/00

(52) U.S. Cl. 362/376; 362/378; 362/344

(57) ABSTRACT

A protective grill for use of the working light, wherein at least one end of an aligning rod is installed with a U-shaped hook portion, and the free end of such U-shaped hook portion is located on the front side; thus the present invention, with the design of the U-shaped hook portion, enables manufacturers to produce protective grills without considering the degree of precision, also the protective grills of the present invention can be installed easily and hard to be loosened from the working lights the protective grills attach to.

### BACKGROUND OF THE INVENTION

1. Field of the Invention

The present invention relates to a protective grill for use of the working light, which provides the user with safer and convenient operation of the working light, for the protective grill can be easily fitted into the housing of the working light, and it can be tightly attached to the housing and hard to be loosened.

2. Description of the Prior Art

Working lights have become indispensable for users who work at night and need supplementary illumination. The prior art regarding working lights mainly comprises a housing, a light bulb installed within the housing, and a protecting grill jointed on the front side of the housing. It is either for job sites or individual users that working lights are to be designed as portable, standing or fixed-positioning. Also an important component—the protective grill—is installed on the working light to prevent the user from being burned by heat released from the 500-Watt halogen bulbs.

According to the Regulation of the U.S. Working Light Safety, if the working light were to pass the ground-dropping test from all angles, its protective grill cannot be detached from the working light; also the protective grill cannot be removed with only a single operation procedure.

Therefore, to be in accordance with such Regulation of the U.S. Working Light Safety, many manufacturers of working lights have been concentrating on producing protective grills of working lights with characteristics of not easy to be detached and removed. However, such manufacturers have failed to notice an important issue of how to manufacture protective grills with characteristics of easy to produce and convenient to assemble.

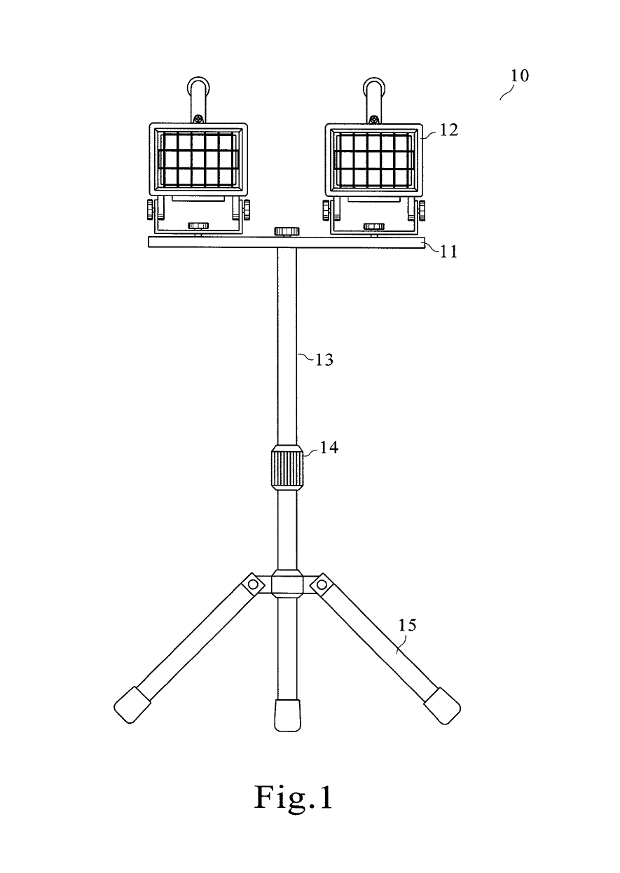

As shown in FIG. 1, the standing working light 10 comprises a cross bar 11, the working lights 12, an extension pole 13, a fixing apparatus 14 and supporting legs 15. The cross bar 11 is for holding working lights 12; the various degrees of height of the extension pole 13 are to be fixed by the fixing apparatus 14, and the upper end of the extension pole is jointed with the cross bar 11; the supporting legs 15 are jointed at the lower end of the extension pole 13 to support the extension pole 13.

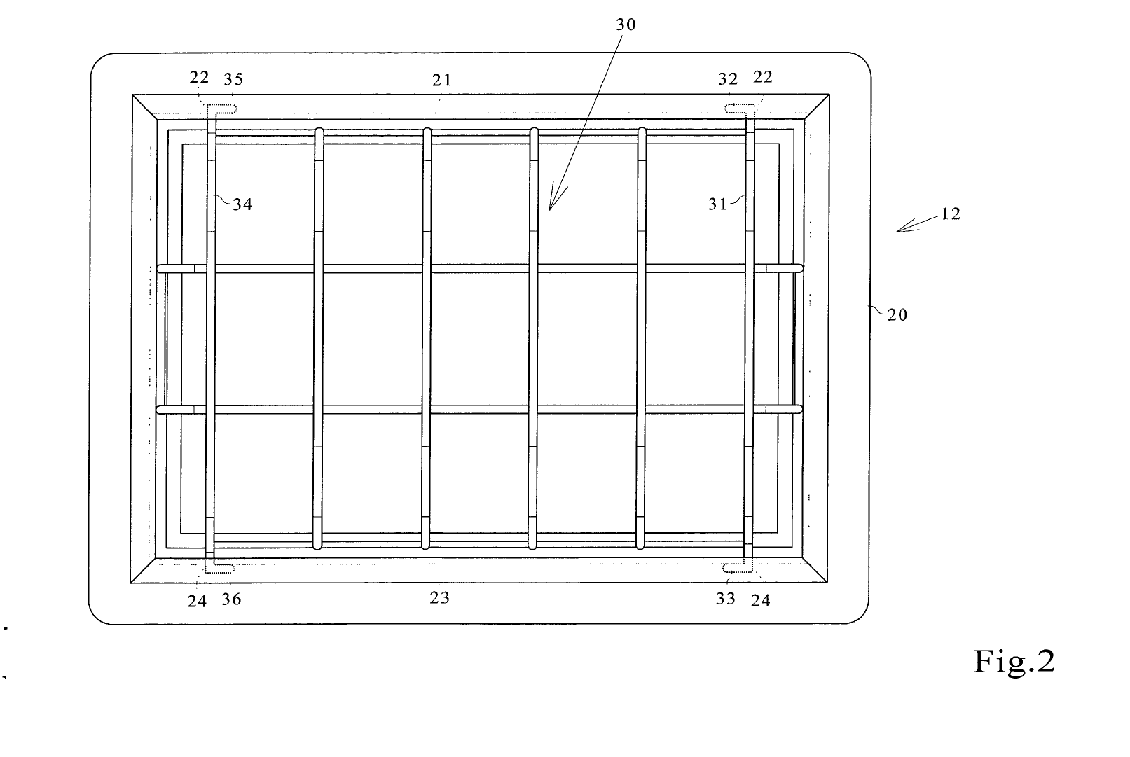

As shown in FIG. 2, the conventional protective grill 30, formed by a multiple of horizontally and vertically jointed metal rods, comprises two aligning rods 31 and 34 installed vertically on the outside for the purpose of attaching the protective grill 30 to the housing 20 of the working light 12, by using the upper end hook portions 32 and lower end hook portions 33 to respectively set into the holes 22 of the upper-inner wall 21 and the holes 24 of the lower-inner wall 23 on the front side of the housing 20; thus the user can avoid any direct contact with the light bulb (not shown in figures) installed in the housing 20.

However, the common differences of the hook portions 32 and 33 of the protective grill 30 have to be small, so the protective grill 30 can be fitted into the holes 22 and 24 of the upper-inner wall 21 and the lower-inner wall 23 of the housing 20, or it is to be hard for the protective grill 30 to be attached or too easy to be removed. Nevertheless, it is not easy to produce the hook portions 32 and 33 with small common differences; if the common differences are huge, the protective grill 30 cannot be attached to the housing 20; if the common differences are small, it is going to be too easy for the protective grill to be detached from the housing 20.

Other manufacturers have developed another design of the protective grill with one comprising a multiple of horizontally and vertically jointed metal rods without any aligning rods having hook portions. Thus, when installing such protective grill, it is necessary for the user to follow the laborious steps of unscrewing the screws, opening up the front frame of the housing, removing the glass within the front frame, installing inside-out the protective grill within the front frame, installing the glass back within the front frame, closing up the front frame of the housing, and finally screwing the screws. Obviously this kind of design lacks the element of expediency.

### SUMMARY OF THE INVENTION

The main object of the present invention is to provide a protective grill for use of the working light, wherein the aligning rods are installed on at least one end with U-shaped hook portions, and the free ends of such hook portions are installed on the front sides.

Another object of the present invention is to provide a protective grill of the working light, wherein the two ends of the aligning rods are installed with U-shaped hook portions and the free ends of such U-shaped hook portions are all installed on the front sides.

The protective grill of the working light provided by the present invention can be manufactured with ease without considering the degree of precision, and such protective grills are easy to assemble and hard to remove.

### BRIEF DESCRIPTION OF THE DRAWINGS

These and other features, aspects and advantages of the present invention will become better understood with regard to the following description, appended claims and accompanying drawings for the purpose of elaborating, but not limiting, where:

1. FIG. 1 shows a front view of a conventional standing working light,

2. FIG. 2 shows a front structural view of a protective grill and a housing of a conventional working light jointed together embodied in a conventional standing working light shown in FIG. 1,

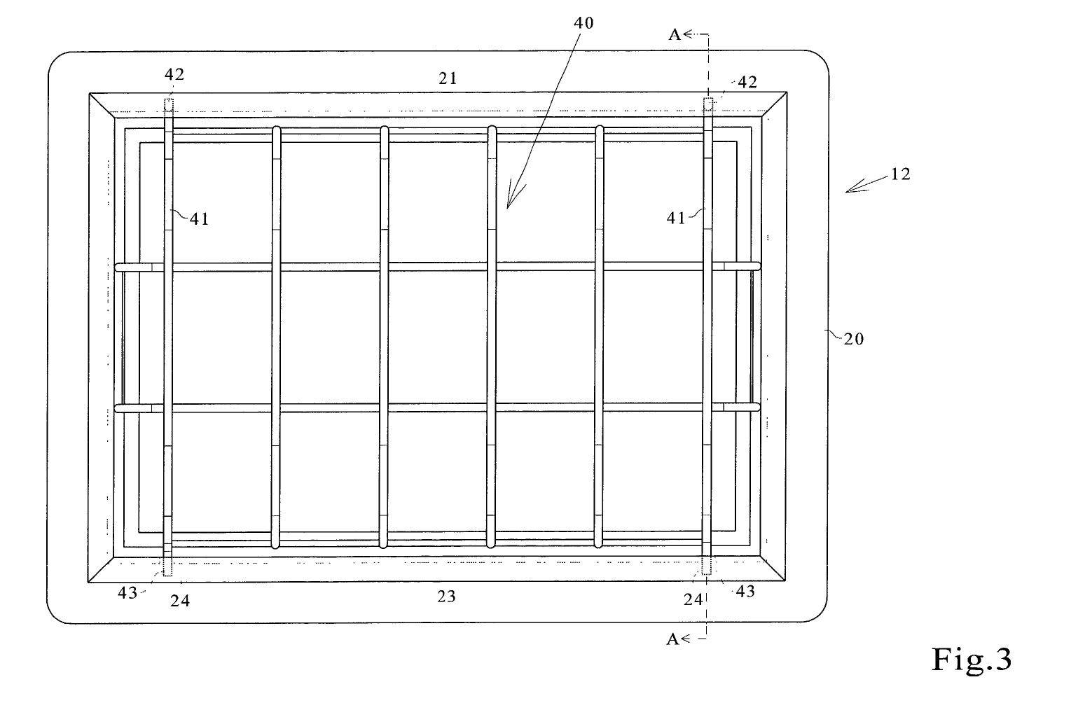

3. FIG. 3 shows a front structural view of a protective grill of the present invention and a housing of a conventional working light jointed together,

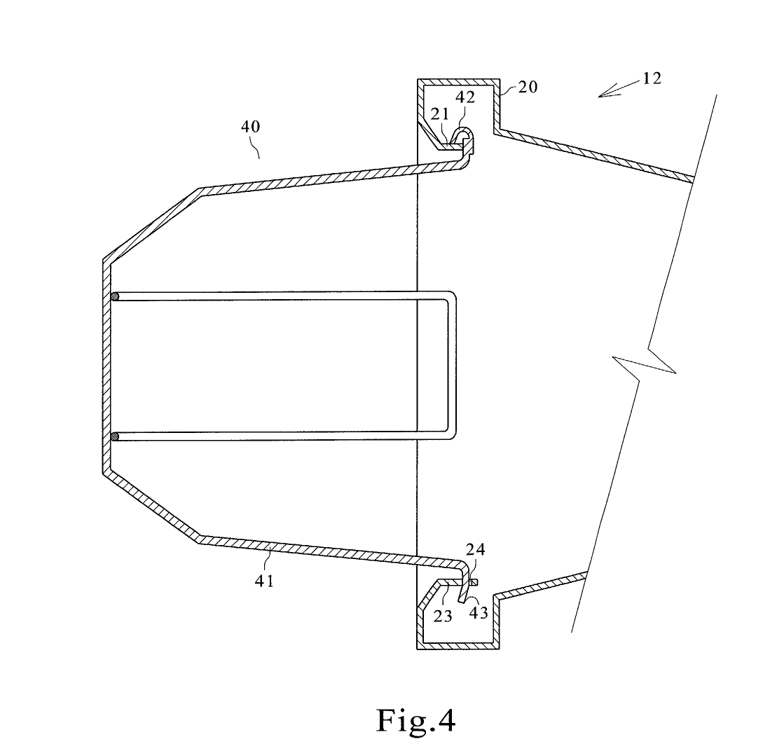

4. FIG. 4 shows a cross-sectional structural view of the line from A to A in FIG. 3, and

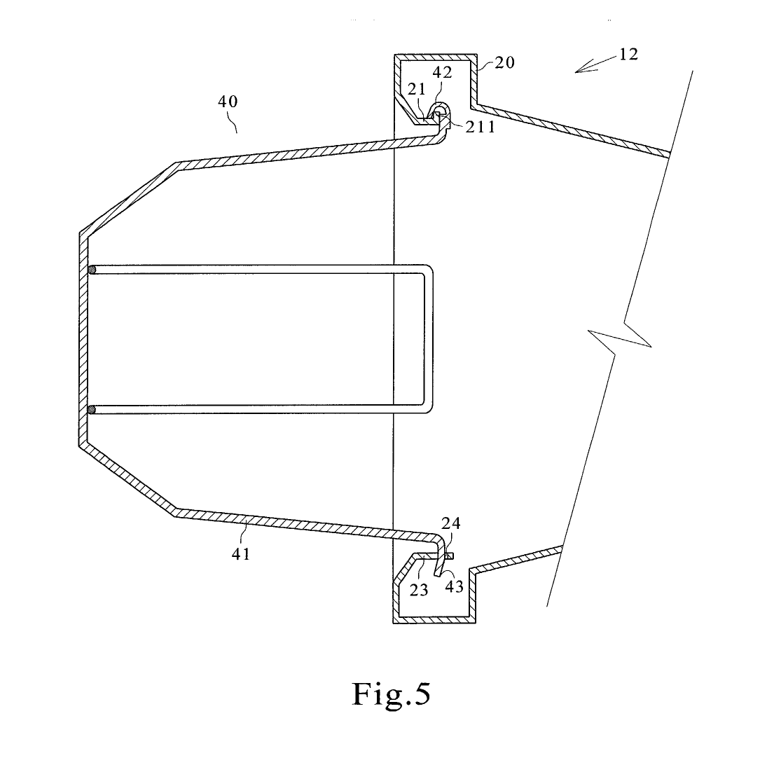

5. FIG. 5 shows a cross-sectional structural view of another embodiment of the present invention, wherein a protective grill of the present invention and a housing of a conventional working light are jointed together.

### DETAILED DESCRIPTION OF THE PREFERRED EMBODIMENTS

As shown in FIG. 3 and FIG. 4, the protective grill 40 of the present invention is mainly installed with the U-shaped hook portions 42 on one end (the upper end in the embodiment of the present invention) of at least a pair of vertical aligning rods 41, and the free ends of the U-shaped hook portions 42 are on the front side (the left side in FIG. 4); the preferred embodiment of the U-shaped hook portion 42 are to be elastic, thus the U-shaped hook portion 42 can be made of both the same material as that of the aligning rods 41, and different material from that of aligning rods 41. And yet both can be integrally formed through soldering.

The aligning rods 41 comprise the extension portions 43 to correspond with the other ends of the U-shaped hook portions 42. The other components of the protective grill of the present invention, like a multiple of horizontally and vertically jointed metal rods, are identical to those of the conventional protective grill 30.

To be in accordance with the protective grill 40 of the present invention, indented portions or holes 24 shall be installed in the lower-inner wall 23 of the housing 20 to correspond with the extension portions 43 of the aligning rods 41; yet no indented portions or holes are needed to be installed in the upper-inner wall 21 of the housing 20, which corresponds with the U-shaped hook portions 42 of the aligning rods 41.

Next is the further elaboration on the assembly of the protective grill 40 of the present invention and the conventional housing 20.

Before assembly, the length of the aligning rods 41 is longer than that between the upper-inner wall 21 and lower-inner wall 23. During assembly, the user may place the U-shaped hook portions 42 of the protective grill 40 into the housing 20 and hook onto the upper-inner wall 21; and then, the user may push the upper and lower surface of the protective grill 40, so as to elastically deform the protective grill 40, thus shorten the length of the aligning rods 41 until the extension portions 43 of the lower end of the aligning rods 41 is set into the holes 24 installed in the lower-inner wall 23 of the housing 20. Yet the foregoing procedure of assembly can be reversely done to complete the assembly. As shown in FIG. 3 and FIG. 4, the assembly of the protective grill 40 and the housing 20 is thus completed according to the foregoing procedure; with the installment of the protective grill 40, the user can avoid any directly contact with the light bulb installed in the housing 20 (not shown in drawings).

FIG. 5 shows another embodiment of jointing the protective grill 40 of the present invention and the conventional housing 20. The difference between FIG. 5 and FIG. 4 is that a vertically protruding portion 211 is installed at the end of the free end of the upper-inner wall 21 of the housing 20, thus the protective grill 40 and the housing 20 can be jointed more tightly.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

What is claimed is:

1. A protective grill for use of the working light, comprising at least one aligning rod and at least one end thereof is installed with a U-shaped hook portion, and the free end of said U-shaped hook portion is located on the front side.

2. A protective grill for use of the working light as in claim 1, wherein the other end of said aligning rod is of an extension portion.

3. A protective grill for use of the working light as in claim 1, wherein the other end of said aligning rod is installed with a U-shaped hook portion, and the free end of said U-shaped hook portion is located on the front side.
